(19) United States
(12) Patent Application Publication
(10) Pub. No.: US 2010/0285367 A1
(43) Pub. Date: Nov. 11, 2010

(54) NEGATIVE ELECTRODE ACTIVE MATERIAL FOR NON-AQUEOUS ELECTROLYTE SECONDARY BATTERY, METHOD FOR PRODUCING THE SAME, AND NON-AQUEOUS ELECTROLYTE SECONDARY BATTERY

(76) Inventors: Tooru MATSUI, Osaka (JP); Masaya Ugaji, Osaka (JP)

Correspondence Address: MCDERMOTT WILL & EMERY LLP, 600 13TH STREET, NW, WASHINGTON, DC, 20005-3096, US

(21) Appl. No.: 12/768,126

(22) Filed: Apr. 27, 2010

(30) Foreign Application Priority Data
May 8, 2009 (JP) 2009-113777

(51) Int. Cl. H01M 4/58; H01M 4/88

(52) U.S. Cl. 429/231.95; 252/182.1

(57) ABSTRACT

A negative electrode active material for a non-aqueous electrolyte secondary battery includes an element capable of forming an intermetallic compound with lithium. The negative electrode active material has a water content of 0 to 0.04 molecule per atom of the element. The non-aqueous electrolyte secondary battery includes a negative electrode including the negative electrode active material, a positive electrode, a separator separating the negative electrode and the positive electrode, and a non-aqueous electrolyte.

### FIELD OF THE INVENTION

The invention relates to non-aqueous electrolyte secondary batteries, and more particularly, to an improvement in negative electrode active materials for use in non-aqueous electrolyte secondary batteries.

### BACKGROUND OF THE INVENTION

Non-aqueous electrolyte secondary batteries, such as lithium ion batteries, are used as the power source for portable electronic devices, such as notebook personal computers, cell phones, and small game machines. Also, with the recent increase in the performance and functionality of portable electronic devices, non-aqueous electrolyte secondary batteries are required to provide increased energy density.

To increase the energy density of non-aqueous electrolyte secondary batteries, it is necessary to heighten the operating voltage of the battery or increase the electrical capacity of the battery. However, heightening the operating voltage of the battery may promote side reactions on the positive and negative electrodes in contact with the non-aqueous electrolyte, thereby affecting the battery reliability significantly. On the other hand, to increase the electrical capacity of the battery, it is necessary to increase the amount of lithium (Li) which can be absorbed in the negative electrode active material per unit volume while making the Li electrochemically active. In addition, the electrochemically active Li needs to be released from the negative electrode active material at a practically sufficient rate.

Recently, attempts have been made to use compounds containing elements capable of forming an intermetallic compound with Li as the negative electrode active materials for non-aqueous electrolyte secondary batteries, instead of commonly used, layered carbon materials such as artificial graphite and natural graphite. Such compounds are materials capable of absorbing large amounts of Li per unit volume, and examples of such elements include silicon (Si) and tin (Sn).

However, since Li is highly reducing, Li in a negative electrode active material easily reacts with a supporting salt contained in a non-aqueous electrolyte such as LiPF₆, non-aqueous solvents such as ethylene carbonate and diethyl carbonate, polymer electrolyte components such as polyethylene oxide and polyvinylidene fluoride, and the like. Such reactions cause deposition of electrochemically inactive Li on the surface of the negative electrode active material, thereby reducing the amount of electrochemically active Li in the negative electrode active material. In addition, an increase in the amount of inactive Li compound on the negative electrode active material surface interferes with the Li ion transfer between the negative electrode active material and the non-aqueous electrolyte. It is noted that the amount of electrochemically inactive Li contained in a negative electrode active material, and active Li which is contained in the negative electrode active material but cannot be released therefrom at a practically sufficient rate, is called irreversible capacity.

Generally, a compound containing an element capable of forming an intermetallic compound with Li undergoes significantly large volume changes when it absorbs Li (expansion) and releases Li (contraction). Thus, when such a compound used as a negative electrode active material is subjected to repeated charge/discharge, the negative electrode active material itself collapses with time, thereby separating from the negative electrode. This phenomenon causes a decrease in the electrical capacity of the negative electrode, leading to a decrease in the electrical capacity of the whole battery.

To address such a problem, International Publication No. WO 2006/011290 (hereinafter “Patent Document 1”) examines the use of silicon oxide (SiO) as a negative electrode active material, and proposes that the SiO contain hydrogen, in order to suppress the expansion and contraction due to lithium absorption and desorption. In Patent Document 1, the concentration of hydrogen in the SiO is set to 80 ppm or more.

Also, International Publication No. WO 01/029913 (hereinafter “Patent Document 2”) describes the use of amorphous silicon or microcrystalline silicon as a negative electrode active material. Patent Document 2 describes that the amorphous region of silicon alleviates the expansion and contraction due to lithium absorption and desorption.

### BRIEF SUMMARY OF THE INVENTION

An element capable of forming an intermetallic compound with Li, such as Si, increases the electrical capacity of a negative electrode active material. However, when Si is used as a negative electrode active material in a non-aqueous electrolyte secondary battery, a significantly large amount of hydrogen is produced when the battery is subjected to a first charge/discharge. This is probably because hydrogen atoms bound to the Si are replaced with lithium atoms due to the battery charge/discharge, thereby becoming hydrogen gas.

The production of hydrogen gas leads to a decrease in electrical capacity that can be used for battery reaction, i.e., an increase in irreversible capacity. This also results in an increase in the amount of hydrogen gas accumulated between the negative electrode and the separator and a resultant decrease in effective electrode area. Consequently, it becomes difficult to charge and discharge the battery at high current.

Therefore, the removal of hydrogen from the negative electrode active material has been examined. However, even when hydrogen is removed, water molecules tend to be included in the negative electrode active material. Since such water included in the negative electrode active material also can cause the production of hydrogen gas during battery charge, it is important to remove moisture included in the negative electrode active material, in order to solve the problem of gas production.

The invention can provide a negative electrode active material capable of suppressing an increase in irreversible capacity due to charge/discharge and a resultant decrease in electrical capacity, and a method for producing the negative electrode active material.

The negative electrode active material for a non-aqueous electrolyte secondary battery according to the invention includes an element capable of forming an intermetallic compound with lithium, and the negative electrode active material is characterized by having a water content of 0 to 0.04 molecule per atom of the element.

The method for producing a negative electrode active material for a non-aqueous electrolyte secondary battery according to the invention is characterized by heating a simple substance of an element capable of forming an intermetallic compound with lithium or a compound containing the element in the presence of lithium nitrate to produce a negative electrode active material having a water content of 0 to 0.04 molecule per atom of the element.

The non-aqueous electrolyte secondary battery according the invention includes a negative electrode including the above-mentioned negative electrode active material; a positive electrode; a separator separating the negative electrode and the positive electrode; and a non-aqueous electrolyte.

The use of the negative electrode active material for a non-aqueous electrolyte secondary battery according to the invention can provide a high capacity non-aqueous electrolyte secondary battery in which the irreversible capacity is reduced.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWING

FIG. 1 is a schematic longitudinal sectional view of a lithium ion battery in an embodiment of the invention.

### DETAILED DESCRIPTION OF THE INVENTION

The negative electrode active material of the invention for a non-aqueous electrolyte secondary battery (hereinafter may be referred to as simply “negative electrode active material”) contains an element M capable of forming an intermetallic compound with Li. Examples of such elements M include Si, Sn, aluminum (Al), zinc (Zn), gallium (Ga), germanium (Ge), arsenic (As), silver (Ag), cadmium (Cd), indium (In), antimony (Sb), platinum (Pt), gold (Au), mercury (Hg), lead (Pb), and bismuth (Bi). The negative electrode active material may contain these elements singly or in combination.

Among these elements, Si or Sn is preferable as the element M, in order to obtain a negative electrode active material capable of absorbing a large amount of Li per unit volume. Si and Sn are also preferable when the negative electrode active material is formed into a thin film, as described later.

The negative electrode active material of the invention may contain one or more other elements M_{C} in addition to the element(s) M capable of forming an intermetallic compound with Li. Examples of elements M_{C} that can be coexistent with the element(s) M include oxygen (O), carbon (C), titanium (Ti), vanadium (V), chromium (Cr), manganese (Mn), iron (Fe), cobalt (Co), Ni (nickel), copper (Cu), zirconium (Zr), niobium (Nb), molybdenum (Mo), and tungsten (W). These coexistent elements M_{C} have the effect of suppressing the expansion of the negative electrode active material during charge.

The atomic ratio between the element(s) M capable of forming an intermetallic compound with lithium and the coexistent element(s) M_{C} may be definite or may be non-stoichiometric. Also, the coexistent element(s) M_{C} may be dispersed in the matrix of the element(s) M. Provided that the atomic ratio between the element(s) M and the coexistent element(s) M_{C} is definite, the negative electrode active material may comprise one or more compounds containing the element(s) M and the coexistent element(s) M_{C}. The ratio of the coexistent element(s) M_{C} to the total of the element(s) M and the coexistent element(s) M_{C} is 50 at % (atomic %) or less, preferably 5 to 30 at %, and more preferably 10 to 20 at %.

The negative electrode active material may be in any form if it contains the element M capable of forming an intermetallic compound with Li. For example, the negative electrode active material may be a simple substance of the element M or a compound containing the element M (an oxide, boride, nitride, sulfide, hydrate thereof, halide, salt (an inorganic or organic acid salt, an inorganic or organic base salt, etc.), organic compound, etc.). Among these substances, a simple substance of the element M or an oxide of the element M is often used. In the case of using a simple substance of the element M (e.g., silicon simple substance such as silicon powder), the water content in the negative electrode active material can be reduced relatively easily by vacuum heating.

The negative electrode active material of the invention is preferably an oxide. The composition thereof is preferably represented by the formula: MOₓ wherein x represents the atomic ratio of oxygen (O) to the element M. In the composition represented by the formula: MOₓ, the number of M atoms preferably exceeds the number of O atoms, i.e., 0<x<1.

When the negative electrode active material containing the element M is an oxide, i.e., 0<x, it is also possible to reduce the water content of the negative electrode active material by vacuum heating.

If the amount of oxygen in the negative electrode active material is excessive, i.e., x exceeds the above-mentioned range, O may react with Li during charge. Such reaction tends to result in large irreversible capacity.

The range of x is usually 0.05 to 0.98 (e.g., 0.07 to 0.95), preferably, 0.1 to 0.9 (e.g., 0.11 to 0.6), and more preferably 0.12 to 0.5 (e.g., 0.15 to 0.3).

In the negative electrode active material of the invention, the water content per atom of the element M is 0.04 molecule or less (0 to 0.04 molecule), preferably 0 to 0.02 molecule (e.g., 0.0001 to 0.02 molecule), and more preferably 0.0002 to 0.01 molecule (e.g., 0.0003 to 0.002 molecule).

When the water content is set in the above range of the number of molecules per atom of the element M, production of hydrogen gas due to charge/discharge can be suppressed. It is thus possible to suppress an increase in irreversible capacity due to charge/discharge and a resultant decrease in electrical capacity. Therefore, the negative electrode active material of the invention can provide a non-aqueous electrolyte secondary battery with high capacity and good cycle characteristics.

The water content can be measured with a thermal desorption mass spectrometer. More specifically, using such a spectrometer, a negative electrode active material is heated from room temperature to 1000° C. at a temperature increase rate of 1° C./sec to measure the amount of moisture released from the negative electrode active material in this heating process. From the measured amount of moisture, the amount of moisture adsorbed on the negative electrode active material (adsorbed water) is subtracted to obtain the water content. The obtained amount of water, expressed as the number of water (H₂O) molecules per atom of the element M contained in the negative electrode active material, is used as the water content.

Adsorbed water is released when the negative electrode active material is heated to 140° C. Thus, the water content can be measured by heating the negative electrode active material at 140° C. to remove adsorbed water in advance, and re-heating the negative electrode active material from which the adsorbed water has been removed in the above-mentioned temperature increase condition.

The water content of the negative electrode active material, as used in the invention, does not refer to the amount of adsorbed water but refers to the amount of water bound to elements (e.g., element M) contained in the negative electrode active material, and such water includes water components present in the form of MOH or MOH₂. For example, when the element M is Si, water is thought to be present not as H₂O but as SiOH or SiOH₂. SiOH and SiOH₂ are inherently difficult to react with Li. Excessive amount of water causes the production of hydrogen evidently during charge. It is thus effective to set the water content per atom of the element M to 0 to 0.04 molecule.

According to the invention, the use of the above-described negative electrode active material can provide a high capacity non-aqueous electrolyte secondary battery in which the irreversible capacity is reduced. Also, the negative electrode active material produces little gas, thereby making it possible to suppress gas accumulation on the negative electrode surface. Further, since the reaction between the negative electrode active material and the non-aqueous electrolyte is suppressed, deposition of reaction products on the negative electrode surface can be suppressed. Hence, the charge/discharge reactions of the negative electrode proceed smoothly, thereby making it possible to provide a non-aqueous electrolyte secondary battery with high output and good cycle characteristics.

The negative electrode active material of the invention can be produced by removing moisture from a raw material containing such an element M so as to adjust the water content per atom of the element M to 0 to 0.04 molecule. The moisture can be removed by simply heating the raw material or heating it at a low pressure (e.g., under vacuum). The moisture can also be removed by treating the raw material with a dehydrating agent. In a preferable method, the water content of the negative electrode active material is adjusted in the above range by heating the raw material at a low pressure or in the presence of lithium nitrate. Examples of raw materials containing such an element M include a simple substance of the element M or compounds (e.g., oxides) containing the element M.

Also, the negative electrode active material of the invention can also be produced by suppressing the inclusion of moisture in a synthesis process of the active material (e.g., step of synthesizing an oxide).

In a preferable production method, a raw material containing an element M is heated in the presence of lithium nitrate to produce a negative electrode active material having a water content of 0 to 0.04 molecule per atom of the element.

Lithium nitrate changes to lithium oxide (Li₂O) when heated, and part of the Li₂O reacts with the raw material containing the element M. As a result of this reaction, the hydrogen atoms in the raw material are replaced with lithium atoms. The hydrogen atoms react with Li₂O to form hydroxyl groups, which are easily removable. The hydroxyl groups can be easily removed as water from the negative electrode active material, for example, by heating the negative electrode active material at a low pressure.

When the water content of the negative electrode active material is reduced by such a production method, the lithium ion conduction paths in the negative electrode active material are expanded. Specifically, when the water content is 0 to 0.04 molecule per atom of the element M, lithium ions can be smoothly transferred in the negative electrode active material. Thus, the above production method can provide a negative electrode active material suitable for a high capacity non-aqueous electrolyte secondary battery.

In the above production method, part of the Li₂O remaining on the surface of the raw material reacts with carbon dioxide in the air, so that it changes to lithium carbonate (Li₂CO₃). When the Li₂CO₃ is adhering to the surface of the negative electrode active material, it can suppress reductive decomposition of the non-aqueous electrolyte on the surface of the negative electrode active material while facilitating the lithium ion transfer between the negative electrode active material and the non-aqueous electrolyte.

More specifically, the negative electrode active material of the invention can be prepared by any of the following methods (i) to (iii).

### Method (i)

Lithium nitrate and, if necessary, a small amount of hydrofluoric acid are added to a raw material containing an element M (a simple substance of an element M, or a compound containing an element M, e.g., a powder of an oxide), followed by heating.

An oxide can be obtained, for example, by forming a thin film of an oxide containing an element M (e.g., a thin film of an oxide of an element M) on a surface of a substrate in an oxygen-containing atmosphere by deposition or sputtering, cooling the thin film, and pulverizing the thin film. In the case of a simple substance of an element M, for example, a melted simple substance of an element M (e.g., metal) is quenched and pulverized to a powder for use. The powder is then heated at a low pressure (e.g., vacuum heating) to reduce the water content. The heating temperature is, for example, 100 to 1000° C., preferably 150 to 950° C., and more preferably 300 to 850° C. (e.g., 400 to 800° C.). Also, the pressure is, for example, vacuum to 0.1 MPa, and preferably 0.0001 to 0.05 MPa.

The amount of lithium nitrate added is, but not limited to, for example, 0.01 to 0.3 mol, preferably, 0.02 to 0.2 mol, and more preferably 0.04 to 0.1 mol, per mol of the element M of the raw material.

If the amount of lithium nitrate is too small, the reduction in the water content of the negative electrode active material may not be sufficient. Conversely, if the amount of lithium nitrate is excessive, the amount of lithium carbonate adhering to the surface of the negative electrode active material after the heat treatment may become excessive, thereby impeding the lithium ion transfer into the negative electrode active material and electron transfer reaction.

Hydrofluoric acid promotes the permeation of lithium nitrate into the raw material containing the element M, thus being suitable for reducing the water content of the raw material containing the element M. The amount of hydrofluoric acid added is, but not limited to, for example, 0.03 mol or less, preferably 0.001 to 0.02 mol, and more preferably 0.004 to 0.01 mol, per mol of the element M of the raw material. If the amount of hydrofluoric acid is excessive, for example, when the element M is Si, the negative electrode active material may become electrochemically inactive due to decomposition.

The addition of lithium nitrate and optionally hydrofluoric acid to the raw material containing the element M may be performed by bringing the raw material into contact with an organic solvent solution (hereinafter may be referred to as simply “solution”) containing lithium nitrate and optionally hydrofluoric acid and then drying it. The drying may be performed at normal pressure or reduced pressure depending on the kind of the organic solvent. Also, the drying temperature can be selected suitably depending on the temperature at which the organic solvent volatilizes.

Examples of the organic solvent include aliphatic alcohols such as methanol and ethanol; ketones such as acetone and methyl ethyl ketone; nitriles such as acetonitrile; ethers such as diethyl ether and tetrahydrofuran; amides such as dimethylformamide; and sulfoxides such as dimethyl sulfoxide. These organic solvents can be used singly or in combination.

The raw material with lithium nitrate and optionally hydrofluoric acid added thereto is then heated, and if necessary, cooled. The heating temperature is, for example, approximately 150 to 800° C., preferably 200 to 750° C., and more preferably 300 to 700° C. (e.g., 400 to 650° C.).

The cooling may be performed by leaving the heated raw material at room temperature, or may be performed gently or rapidly while controlling temperature decrease using a known heat insulator or a cooling device.

The heating or cooling may be performed in an inert gas atmosphere containing carbon dioxide. When the heating or cooling is performed in such an atmosphere, it is possible to obtain a low water-content negative electrode active material whose surface is covered with lithium carbonate due to decomposition of the lithium nitrate. Examples of inert gases include helium, argon, and mixed gases thereof. The concentration of carbon dioxide in the inert gas is, for example, approximately 0.1 to 10% by volume, preferably 0.5 to 8% by volume, and more preferably 1 to 6% by volume.

### Method (ii)

A raw material containing an element M (a simple substance of an element M, an oxide containing an element M, etc.) is heated at a low pressure.

The raw material containing the element M may be in the form of a thin film or powder. A thin-film raw material can be obtained, for example, by forming a thin film containing the element M on a surface of a substrate by deposition or sputtering. When the deposition or sputtering is performed in an oxygen atmosphere, a thin film of an oxide containing the element M can be obtained. A powder raw material can be obtained by pulverizing the above-mentioned thin-film raw material or by quenching a melted simple substance of the element M (metal or the like) and pulverizing it.

The temperature for heating the raw material containing the element M is, for example, 100 to 1000° C., preferably 150 to 950° C., and more preferably 300 to 900° C. (e.g., 400 to 850° C.). Also, the pressure for low pressure heating is, for example, vacuum to 0.1 MPa, and preferably 0.0001 to 0.05 MPa.

Method (iii)

In an oxygen-containing atmosphere, an element M (preferably Si and/or Sn) is deposited or sputtered on a surface of a negative electrode current collector to form a thin film, which is then heated in the presence of lithium nitrate.

According to this method, a thin film of a negative electrode active material (oxide MOₓ) is formed directly on the surface of the negative electrode current collector (e.g., copper foil) by deposition or sputtering.

To reduce the water content of the oxide containing the element M, the thin-film oxide (e.g., MOₓ) is heated in the presence of lithium nitrate by the above method. At this time, it may be heated to a temperature at which the copper foil and the element M form an intermetallic compound.

The heating temperature can be selected from the same range as that of the method (i). When the element M is Si, the heating temperature can be selected, for example, from the range of approximately 300 to 900° C., preferably, 400 to 800° C., and more preferably 450 to 750° C.

Such heat treatment allows the moisture contained in the oxide to be removed sufficiently, thereby making it possible to adjust the water content per atom of the element M to 0 to 0.04 molecule.

The heating may be performed in an inert gas atmosphere containing carbon dioxide in the same manner as in the method (i), and cooling may be performed in such an atmosphere after the heating. The cooling method, the kind of the inert gas, and the carbon dioxide concentration in the inert gas can be selected from those as described above.

The addition of lithium nitrate to the raw material may be done by bringing the thin-film raw material into contact with the above-mentioned organic solvent solution containing lithium nitrate and drying it. The addition of lithium nitrate may be done by spraying the organic solvent solution on the thin film made of the raw material. The amount of lithium nitrate added can be selected from the same ranges as those described above.

When a thin film of MO_{X} is formed directly on a surface of a negative electrode current collector, the amount of lithium nitrate added may be reduced to suppress the oxidation of the copper foil serving as the negative electrode current collector. In this case, the amount of lithium nitrate added is, but not limited to, for example, 0.1 mol or less (0.01 to 0.1 mol), preferably 0.01 to 0.08 mol, and more preferably 0.02 to 0.06 mol, per mol of the raw material containing the element M.

The non-aqueous electrolyte secondary battery of the invention includes a negative electrode containing the negative electrode active material of the invention, a positive electrode, and a separator separating the negative electrode and the positive electrode, and a non-aqueous electrolyte. This non-aqueous electrolyte secondary battery is not particularly limited except for the use of the negative electrode active material of the invention. With respect to other components than the negative electrode active material and the configurations of the negative electrode, the positive electrode, etc, various components and configurations in the field of the invention may be used as appropriate. The non-aqueous electrolyte secondary battery uses the negative electrode active material capable of suppressing an increase in irreversible capacity, a resultant decrease in electrical capacity, and gas production. Therefore, the non-aqueous electrolyte secondary battery has a high capacity and good cycle characteristics.

Examples of the non-aqueous electrolyte secondary battery of the invention include various secondary batteries using non-aqueous electrolytes, such as lithium ion batteries. Also, the non-aqueous electrolyte secondary battery of the invention may have various shapes such as layered, cylindrical, prismatic, coin, sheet, button, and flat shapes as appropriate.

An embodiment of the non-aqueous electrolyte secondary battery of the invention is hereinafter described in detail with reference to a layered lithium ion battery as an example.

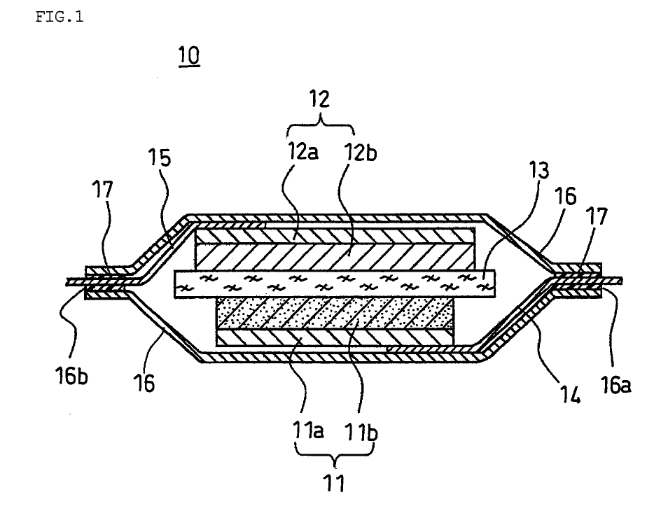

FIG. 1 is a schematic longitudinal sectional view of an example of a layered lithium ion battery. Referring to FIG. 1, a lithium ion battery 10 includes a positive electrode 11, a negative electrode 12, a separator 13 for separating the positive electrode 11 and the negative electrode 12, a non-aqueous electrolyte (not shown), a positive electrode lead 14 electrically connected to the positive electrode 11, a negative electrode lead 15 electrically connected to the negative electrode 12, a casing 16 for holding these components, and gaskets 17 for sealing the casing 16. Also, the lithium ion battery 10 has an electrode assembly composed of the positive electrode 11, the separator 13, and the negative electrode 12 layered in this order.

The lithium ion battery is not to be construed as being limited to the above configuration. The power generation element of the lithium ion battery may comprise a stack of such electrode assemblies. Also, the power generation element may comprise a wound assembly of the positive electrode 11, the separator 13, and the negative electrode 12, each of which is shaped like a strip.

Referring again to FIG. 1, the negative electrode 12 includes a negative electrode current collector 12a and a negative electrode active material layer 12b formed on a surface of the negative electrode current collector 12a. Also, the negative electrode active material layer 12b includes the negative electrode active material for a non-aqueous electrolyte secondary battery according to the invention.

The negative electrode current collector 12a can be a foil of a metal material such as iron, nickel, or copper. Such a metal material may be in the form of an alloy. The thickness of the negative electrode current collector 12a is, but not limited to, for example, approximately 5 to 50 μm.

The negative electrode current collector 12a may be porous or non-porous. For example, when the negative electrode active material is in powder form and the non-aqueous electrolyte (described later) is in liquid form (liquid non-aqueous electrolyte), the negative electrode current collector 12a is preferably porous. When the battery is charged and discharged, the negative electrode active material expands and contracts, so the volume of the pores holding the non-aqueous electrolyte changes. Thus, making the negative electrode current collector 12a porous facilitates the flow of the non-aqueous electrolyte in the electrode assembly composed of the negative electrode 12, the positive electrode 11 (described later), and the separator 13. On the other hand, when the negative electrode active material layer 12b in the form of a thin film is formed directly on a surface of the negative electrode current collector 12a by deposition or the like, the negative electrode current collector 12a is preferably non-porous. In particular, when the non-aqueous electrolyte is in liquid form, the surface of the negative electrode current collector 12a is preferably roughened. The surface roughness of the negative electrode current collector 12a allows the negative electrode active material to grow into columnar particles in the formation of a thin film, thereby allowing a large amount of liquid non-aqueous electrolyte to be held between the columnar particles of negative electrode active material.

When the negative electrode active material is in powder form, the negative electrode active material layer 12b is formed, for example, by mixing a negative electrode active material and, if necessary, various additives such as a thickener, a binder, and a conductive agent with a dispersion medium (liquid component) to form a negative electrode mixture paste, applying it onto a surface of the negative electrode current collector 12a, and drying it. Also, in order to provide good electronic conductivity between the negative electrode active material particles, it is preferable to roll the negative electrode active material layer 12b and the negative electrode current collector 12a after the formation of the negative electrode active material layer 12b. In this case, in consideration of the expansion of the negative electrode active material during charge, it is preferable to suitably adjust the porosity of the negative electrode active material layer 12b so as to avoid stretching or warpage of the negative electrode 12. The porosity of the negative electrode active material layer 12b is, but not particularly limited to, for example, 20 to 60%, and preferably 30 to 50%.

Examples of dispersion media include organic solvents such as N-methyl-2-pyrrolidone, amides (e.g., dimethylformamide, dimethylacetamide, and methylformamide), amines (e.g., dimethylamine), and ketones (e.g., acetone and cyclohexanone). It is preferable that the dispersion medium be sufficiently dehydrated.

Examples of thickeners and binders include: cellulose derivatives (e.g., carboxymethyl cellulose), polyacrylic acids (e.g., polyacrylic acid and polymethacrylic acid), and vinyl alcohols (e.g., polyvinyl alcohol) whose active hydrogen is partially or substantially entirely replaced with Li; ester compounds of polyacrylic acid and polymethacrylic acid; and polyalkylene oxides such as polyethylene oxide. The use of such a thickener or binder is advantageous in terms of reducing the irreversible capacity loss of the non-aqueous electrolyte secondary battery occurring during the initial charge.

Examples of conductive agents include natural graphite, artificial graphite, and carbon blacks such as acetylene black. Among them, natural graphite and artificial graphite are preferable. Carbon black may increase irreversible capacity since it has, on the surface, a large number of functional groups which can contribute to decomposition of the non-aqueous electrolyte.

When the negative electrode active material is formed into a thin film by deposition or the like, it is preferable that a surface of the negative electrode active material layer 12b be sprayed with a solution prepared by dissolving such a thickener and/or binder in such a liquid component as described above, to form a coating layer containing the thickener and/or binder. This further suppresses the reaction between the negative electrode active material and the non-aqueous electrolyte, thereby permitting a decrease in irreversible capacity and an improvement in cycle characteristics.

The positive electrode 11 includes a positive electrode current collector 11a and a positive electrode active material layer 11b formed on a surface of the positive electrode current collector 11a. The positive electrode current collector 11a can be a foil of a metal material such as stainless steel, titanium, aluminum, or an aluminum alloy. The thickness of the positive electrode current collector 11a is, but not limited to, approximately 5 to 50 μm. The positive electrode current collector 11a may be porous or non-porous in the same manner as the negative electrode current collector 12a.

Examples of the positive electrode active material include transition metal oxides such as LiCoO₂, LiCO_{1-y}Mn_{y}O₂, LiCO₁₋ₓNiₓO₂, and LiCO_{1-x-y}Mn_{y}NiO₂. The ratio of Ni to such a transition metal oxide as a whole, i.e., the value x in the above formulae, is preferably 0.5 or less (0.3 to 0.5), and more preferably 0.3 to 0.45. When the Ni content is high, the water content in the positive electrode becomes high, water in the positive electrode eventually enters the negative electrode active material, which can cause production of hydrogen gas in the battery. The value y in the above formulae is preferably 0.1 to 0.5, and more preferably 0.2 to 0.45. Also, it is possible to use such transition metal oxides as LiMn₂O₄ of spinel structure and LiFePO₄ and LiMnPO₄ of olivine structure. In such transition metal oxides, part of the transition metal elements may be replaced with one or more typical elements such as magnesium (Mg) and Al. The ratio of the typical element(s) to the whole metal elements is preferably 0.1 or less (0.03 to 0.1), and more preferably 0.05 to 0.07.

The positive electrode active material layer 11b is formed by mixing a positive electrode active material and, if necessary, various additives such as a binder and a conductive agent with a liquid component to form a paste-like positive electrode mixture, applying it onto a surface of the positive electrode current collector 11a, and drying it. Examples of the liquid component, binder, and conductive agent are the same as those that can be used in the preparation of the negative electrode mixture.

The separator 13 can be a porous sheet or film such as a micro-porous film, woven fabric, or non-woven fabric. The separator 13 can be formed of various resin materials, such as polyolefins including polyethylene and polypropylene and aramids. In particular, in order to make the layered electrode assembly of the positive electrode 11, the separator 13, and the negative electrode 12 fully dry, the separator 13 is preferably made of an aramid, or preferably includes an aramid. The aramid may be applied to the surface of a polyolefin porous sheet or film. In the case where the separator 13 is a polyolefin porous sheet or film, or such a sheet or film with an aramid applied to the surface thereof, for example, when the battery heats up to a high temperature, the polyolefin resin melts, thereby performing a shut down function and enhancing battery reliability, which is preferable.

Examples of the non-aqueous electrolyte include liquid non-aqueous electrolytes, gel electrolytes, polymer electrolytes, and inorganic solid electrolytes. In particular, the non-aqueous electrolyte is preferably liquid (liquid non-aqueous electrolyte) in terms of providing good ionic conductivity of the non-aqueous electrolyte and good ion diffusibility inside the electrodes in a wide temperature range.

The non-aqueous electrolyte includes a lithium salt as a supporting electrolyte and a non-aqueous solvent.

Various lithium salts can be used, and examples include fluorophosphates such as lithium hexafluorophosphate (LiPF₆), lithium trifluorotris(trifluoromethyl)phosphate (LiPF₃(CF₃)₃), and lithium trifluorotris(pentafluoroethyl)phosphate (LiPF₃(C₂F₅)₃); fluoroborates such as lithium tetrafluoroborate (LiBF₄), lithium trifluoro(trifluoromethyl)borate (LiBF₃(CF₃)), and lithium trifluoro(pentafluoroethyl)borate (LiBF₃(C₂F₅)); lithium perchlorate (LiClO₄); bisperfluoroalkanesulfonylimide salts such as lithium bis(trifluoromethanesulfonyl)imide ((CF₃SO₂)₂NLi), lithium bis(pentafluoroethanesulfonyl)imide (C₂F₅SO₂)₂NLi) and lithium bis(heptafluoropropanesulfonyl)imide ((C₃F₇SO₂)₂NLi); cyclic perfluoroalkanesulfonylimide salts such as lithium cyclo-tetrafluoroethane-1,2-bis(sulfonyl)imide ((CF₂SO₂)₂NLi) and lithium cyclo-hexafluoropropane-1,3-bis(sulfonyl)imide (CF₂(CF₂SO₂)₂NLi); and lithium bis(oxalato)borate (Li[B(C₂O₄)₂]).

Examples of the non-aqueous solvent include ethylene carbonate, propylene carbonate, dimethyl carbonate, ethyl methyl carbonate, and diethyl carbonate.

In the invention, in terms of reducing the water content of the non-aqueous electrolyte, the lithium salt and the non-aqueous solvent are preferably hydrophobic. Thus, the lithium salt preferably includes a fluorophosphate or fluoroborate such as LiPF₃(CF₃)₃ or LiBF₃(CF₃) among the above list. Also, the non-aqueous solvent preferably includes a solvent whose alkyl groups are partially or entirely replaced with fluorine-substituted alkyl groups such as —CF₃ or —C₂F₅. Examples of such solvents include 2,2,2-trifluoroethyl methyl carbonate, 3,3,3-trifluoropropyl methyl carbonate, 2,2,3,3-tetrafluoropropyl methyl carbonate, 2,2,3,3,3-pentafluoropropyl methyl carbonate, bis(2,2,3,3-tetrafluoropropyl)carbonate, and bis(2,2,3,3,3-pentafluoropropyl)carbonate.

While the concentration of the lithium salt in the non-aqueous electrolyte is not particularly limited, it is preferably 0.7 to 1.4 mol/L.

An example of materials for the positive electrode lead 14 is aluminum. Also, examples of materials for the negative electrode lead 15 include copper and nickel.

The casing 16 of the lithium ion battery 10 can be made of an aluminum-laminated resin film, an aluminum or aluminum alloy can, an iron or stainless steel can, or the like.

In the above description, a layered lithium ion battery is described as the non-aqueous electrolyte secondary battery of the invention, but the invention is not to be construed as being limited thereto. As described above, it is possible to employ various shapes such as cylindrical, prismatic, coin, sheet, button, and flat shapes. Also, such non-aqueous electrolyte secondary batteries of various shapes can be produced by various methods used in the field of the invention.

### Example 1

### (1) Preparation of Negative Electrode Active Material and Production of Negative Electrode

Si particles with a diameter of approximately 2 mm (available from Kojundo Chemical Lab. Co., Ltd.) were introduced into a planetary ballmill and pulverized in the air until the particle size became submicrons. The mean particle size of the Si powder thus obtained was 800 nm.

The pulverized Si powder was heated from room temperature to 1000° C. at a temperature increase rate of 1° C./sec to measure the amount of moisture released therefrom with a thermal desorption mass spectrometer (EMD-WA1000S available from ESCO Ltd.). The ratio of water molecules per Si atom was calculated based on the amount of water obtained by subtracting the amount of adsorbed water released due to heating to 140° C. from the amount of moisture released due to heating from room temperature to 1000° C. As a result, the water content of the pulverized Si powder per Si atom was found to be 0.06 molecule.

Subsequently, the pulverized Si powder was placed in a glove box having an argon atmosphere (a water concentration of 1 ppm or less and an oxygen concentration of 2 ppm or less), and heated in a vacuum electric furnace directly joined to the glove box at 1 kPa and 700° C. for 1 hour. The water content of the vacuum-heated silicon powder (negative electrode active material) was measured in the same manner as described above, and the water content per Si atom was found to be 0.0003 molecule.

Thereafter, 95 parts by weight of the vacuum-heated silicon powder and 5 parts by weight of dry polyethylene oxide powder (a weight-average molecular weight Mw of a million, available from Sigma-Aldrich Japan) were dispersed in dehydrated dimethoxyethane to prepare a negative electrode mixture paste. This negative electrode mixture paste was applied onto a surface of a copper foil (thickness 10 μm) serving as a negative electrode current collector 12a. Further, the negative electrode mixture was dried, and the negative electrode current collector 12a with the dried negative electrode mixture was rolled to obtain a sheet-like negative electrode 12 having a 50-μm thick negative electrode active material layer 12b on a surface (see FIG. 1). The negative electrode 12 was cut to a length of 35 mm and a width of 35 mm.

In this example, a test lithium ion battery was produced instead of the lithium ion battery illustrated in FIG. 1. In the test lithium ion battery, the negative electrode 12 was bonded to a surface of a copper plate of the same size by ultrasonic welding. A copper lead, used as the negative electrode lead, was welded to the copper plate without being welded to the negative electrode current collector 12a.

### (2) Preparation of Positive Electrode

A positive electrode mixture paste was prepared by mixing 93 parts by weight of LiCoO₂ powder (available from Nichia Corporation), 3 parts by weight of acetylene black, and 4 parts by weight of vinylidene fluoride-hexafluoropropylene copolymer, and dispersing the resultant mixture in dehydrated N-methyl-2-pyrrolidone. This positive electrode mixture was applied onto a surface of an aluminum foil (thickness 15 μm) serving as a positive electrode current collector 11a. Further, the positive electrode mixture was dried, and the positive electrode current collector 11a with the dried positive electrode mixture was rolled to obtain a sheet-like positive electrode 11 having a 65-μm thick positive electrode active material layer 11b on a surface (see FIG. 1). The positive electrode 11 was cut to a length of 35 au and a width of 35 mm.

The positive electrode 11 was bonded to a surface of an aluminum plate of the same size by ultrasonic welding before being used in the test lithium ion battery. An aluminum lead, used as the positive electrode lead, was welded to the aluminum plate without being welded to the positive electrode current collector 11a.

### (3) Preparation of Non-Aqueous Electrolyte

Ethylene carbonate and 2,2,2-trifluoroethyl methyl carbonate, used as non-aqueous solvents, were mixed together in a volume ratio of 1:1. To the solvent mixture of 1 liter were added 0.8 mol of LiPF₆ and 0.2 mol of LiPF₃(C₂F₅)₃, which were dissolved therein to obtain a non-aqueous electrolyte.

### (4) Fabrication of Non-Aqueous Electrolyte Secondary Battery

An aramid separator was interposed between the positive electrode active material layer 11b of the positive electrode 11 and the negative electrode active material layer 12b of the negative electrode 12 to form an electrode assembly. In this electrode assembly, the aluminum plate was bonded to the positive electrode current collector 11a of the positive electrode 11, while the copper plate was bonded to the negative electrode current collector 12a of the negative electrode 12. This electrode assembly was dried at 160° C. in a vacuum for 1 hour. The vacuum-dried electrode assembly was placed in an envelop-shaped casing (a pouch made of an aluminum-laminated resin film) which was open at both ends. The positive electrode lead welded to the aluminum plate was drawn out of one of the two open ends of the casing and, in this state, the open end was sealed by welding. Subsequently, the negative electrode lead welded to the copper plate was drawn out of the other open end of the casing and, in this state, the non-aqueous electrolyte was dropped into the casing from the open end. The casing was then degassed at 10 mmHg for 5 seconds, and the open end on the negative electrode lead side was sealed by welding. A non-aqueous electrolyte secondary battery 10 thus obtained was named battery A.

### (5) Measurement of Discharge Capacity

The battery A was subjected to five charge/discharge cycles at 20° C. at a constant current of 3.5 mA. The cut-off voltage of charge was set to 4.2 V, while the cut-off voltage of discharge was set to 2.5 V. The discharge capacity of the battery after 5 cycles was approximately 28.5 mAh.

### (6) Design Variations in Vacuum Heating Condition

Silicon powders (negative electrode active materials) were prepared in the same manner as described above except that these negative electrode active materials were vacuum heated at different temperatures, and the water contents thereof were measured. Using these negative electrode active materials, non-aqueous electrolyte secondary batteries (batteries B to G, and comparative batteries H to J) were produced in the same manner as the battery A, and the discharge capacities thereof were measured.

Table 1 shows the measurement results of the batteries A to G and the comparative batteries H to J, i.e., the water contents of the silicon powders and the battery discharge capacities.

TABLE 1

| | | Water content of | Battery |
|---|---|---|---|
| | Temperature for | silicon powder | discharge |
| Battery | vacuum heating | (number of H₂O molecules/ | capacity |
| No. | [° C.] | number of Si atoms) | [mAh] |
| H | Not heated | 0.08 | 15.3 |
| I | 60 | 0.07 | 18.4 |
| J | 100 | 0.07 | 23.7 |
| B | 150 | 0.04 | 27.9 |
| C | 300 | 0.01 | 28.4 |
| D | 400 | 0.005 | 28.4 |
| E | 500 | 0.001 | 28.5 |
| F | 600 | 0.0007 | 28.4 |
| A | 700 | 0.0003 | 28.5 |
| G | 800 | 0.0001 | 28.5 |

Table 1 shows that when the water content of the silicon powder exceeds 0.04 molecule per Si atom, the battery discharge capacity lowers sharply. Also, the results of Table 1 indicate that the water content of the silicon powder is desirably 0.01 molecule or less per Si atom. Excessive water content of the silicon powder is thought to result in not only an increase of irreversible capacity of the battery but also accumulation of hydrogen gas in the electrode assembly, thereby reducing the electrochemically active electrode area.

### Example 2

### (1) Preparation of Negative Electrode Active Material

A vacuum deposition device was used to prepare a silicon oxide. A silicon ingot was placed in a chamber in which a cooled stainless steel substrate was disposed. After the pressure of the chamber was reduced, the silicon ingot was irradiated with an electron beam, with a small amount of oxygen being introduced therein. In this way, an amorphous silicon oxide with a composition of SiOₘ₇ was deposited on the stainless steel substrate.

The silicon oxide was scraped off from the stainless steel substrate, and the scraped silicon oxide was introduced into a planetary ballmill and pulverized in an argon atmosphere until the particle size became submicrons.

The pulverized silicon oxide powder was heated at 0.0013 MPa and 600° C. for 5 hours to reduce the water content. The resultant silicon oxide powder had a mean particle size of 880 nm.

The water content of the Si oxide powder was measured in the same manner as in Example 1. The ratio of water molecules per Si atom was calculated, and the water content per Si atom was found to be 0.02 molecule. This silicon oxide powder was named negative electrode active material K.

Lithium nitrate was heated at 100° C. to remove moisture, and 0.1 mol of this lithium nitrate was dissolved in 1 L of dehydrated ethanol. To this solution was added the silicon oxide powder (negative electrode active material K), which was then dried so that the amount of lithium nitrate added was 0.06 mol per mol of silicon in the dried silicon oxide. In this way, lithium nitrate was attached to the surface of the negative electrode active material K. Further, the silicon oxide powder thus obtained was heated at 600° C. to decompose the lithium nitrate, and cooled in an argon gas atmosphere containing 5% by volume of carbon dioxide to convert Li₂O exposed at the surface of the silicon oxide powder to Li₂CO₃. Using this silicon oxide powder, the water content was measured in the same manner as described above, and the water content per Si atom was found to be 0.0008 molecule. This silicon oxide powder was named negative electrode active material L.

### (2) Fabrication of Non-Aqueous Electrolyte Secondary Battery and Measurement of Discharge Capacity

Non-aqueous electrolyte secondary batteries were fabricated in the same manner as in Example 1 except for the use of the negative electrode active material K or L as the negative electrode active material, and subjected to five charge/discharge cycles. The discharge capacities [mAh] of the batteries after 5 cycles were obtained.

As a result, when the negative electrode active material K was used in the negative electrode, the initial discharge capacity was 25.7 mAh, and when the negative electrode active material L was used, the initial discharge capacity was 27.8 mAh. They were both found to be practically satisfactory.

### Example 3

### (1) Preparation of Lithium Electrode

A nickel expanded metal was resistance welded to the tip of a 5-mm wide nickel ribbon. The expanded metal and a lithium metal foil were pressed to obtain a lithium electrode. The lithium electrode was used to add lithium to the negative electrode.

### (2) Fabrication of Non-Aqueous Electrolyte Secondary Battery and Compensation for Irreversible Capacity

A test lithium battery was produced in the same manner as in Example 1 except for the use of the negative electrode active material K prepared in Example 2 as the negative electrode active material. This was named battery K.

The battery K was subjected to five charge/discharge cycles at 20° C., a cut off voltage of charge of 4.2 V, a cut off voltage of discharge of 2.5 V, and a current of 3.5 mA. The discharge capacity of the battery after 5 cycles was approximately 25.6 mAh.

Subsequently, the negative electrode was removed from the battery K in a discharged state. With the negative electrode being the cathode and the lithium electrode being the anode, a current of 0.18 mA was passed between the two electrodes. As a result, lithium corresponding to an electrical capacity of 2.9 mAh was added to the negative electrode. Thereafter, between the positive electrode and the negative electrode, the battery K was again charged and discharged at a constant current of 3.5 mA, and the discharge capacity of the battery was found to be 28.5 mAh.

Likewise, using the negative electrode active material L prepared in Example 2, a test lithium battery was fabricated. This was named battery L. The discharge capacity of the battery L was also adjusted to 28.5 mAh by adding lithium to the negative electrode from the lithium electrode in the same manner as described above.

### (3) Comparison of Cycle Characteristics

The battery A prepared in Example 1 and the batteries K and L with lithium added thereto (a total of three batteries) were subjected to 100 charge/discharge cycles at a cut off voltage of charge of 4.2 V, a maximum charge time of 1.5 hours, a cut off voltage of discharge of 2.5 V, a charge current of 24.5 mA, and a discharge current of 35 mA. Thereafter, at a cut off voltage of charge of 4.2 V, a cut off voltage of discharge of 2.5 V, and a constant current of 3.5 mA, the discharge capacities of the batteries were obtained. Table 2 shows the measurement results.

TABLE 2

| | | |
|---|---|---|
| Battery | Discharge capacity [mAh] | Capacity retention |

| No. | Initial state | After 100 cycles | rate |
|---|---|---|---|
| A | 28.5 | 21.9 | 77% |
| K | 28.5 | 23.9 | 84% |
| L | 28.5 | 25.4 | 89% |

Table 2 shows that the use of a silicon oxide as the negative electrode active material is superior in capacity retention rate to the use of a silicon powder. In particular, it indicates that the use of a silicon oxide heated in the presence of lithium nitrate is superior in capacity retention rate to the use of a silicon powder, although the addition of lithium to the negative electrode is necessary. This is probably because lithium contained in the silicon oxide is present in the form of, for example, SiOLi, thereby providing good lithium conduction paths.

### Example 4

### (1) Preparation of Negative Electrode Active Material

In the process of preparing a silicon oxide powder in Example 2, the oxygen concentration in the chamber was adjusted to prepare silicon oxide powders (negative electrode active materials M to R) having compositions of SiO_{0.12}, SiO_{0.37}, SiO_{0.59}, Si_{0.97}, SiO_{1.1}, and SiO_{1.4}, respectively. The silicon oxide powders were then heated at 800° C. in a vacuum for 1 hour. The water contents of these silicon oxide powders were 0.0004, 0.0007, 0.001, 0.002, 0.003, and 0.004 molecules, respectively, per Si atom. Also, these silicon oxide powders had mean particle sizes of 880 nm, 960 nm, 950 nm, 860 nm, 870 nm, and 890 nm, respectively.

### (2) Fabrication of Non-Aqueous Electrolyte Secondary Battery and Compensation

Using the negative electrode active materials M to R, non-aqueous electrolyte secondary batteries (batteries M to R) were fabricated in the same manner as in Example 3. The discharge capacities of these batteries were obtained at a cut off voltage of charge of 4.2 V, a cut off voltage of discharge of 2.5 V, and a constant current of 3.5 mA. Subsequently, lithium was added to the negative electrode from the lithium electrode so that the discharge capacities of these batteries were 28.5 mAh.

### (3) Comparison of Amount of Gas Produced in Battery

The batteries M to R were subjected to repeated charge/discharge cycles at a cut off voltage of charge of 4.2 V, a maximum charge time of 1.5 hours, a cut off voltage of discharge of 2.5 V, a charge current of 24.5 mA, and a discharge current of 35 mA. After 100 cycles, the gas produced in each battery, such as hydrogen, was collected, and the collected amount was measured. Table 3 shows the measurement results.

TABLE 3

| | | Water content of | |
|---|---|---|---|
| | Composition of | silicon oxide powder | Amount of gas |
| Battery | negative electrode | (number of H₂O molecules/ | produced in |
| No. | active material | number of Si atoms) | battery [mL] |
| M | SiO_{0.12} | 0.0004 | 0.12 |
| N | SiO_{0.37} | 0.0007 | 0.11 |
| O | SiO_{0.59} | 0.001 | 0.13 |
| P | SiO_{0.97} | 0.002 | 0.14 |
| Q | SiO_{1.1} | 0.003 | 0.21 |
| R | SiO_{1.4} | 0.004 | 0.35 |

Table 3 shows that when the ratio x of O to Si exceeds 1 (batteries Q and R), the amount of gas produced in the battery increases sharply. This is probably due to the following reason. An increase in the ratio x of oxygen in the negative electrode active material promotes the absorption of moisture. Due to charge/discharge cycles, the absorbed moisture gradually reacts with Li to produce hydrogen in the battery. Also, hydrofluoric acid produced in side reaction decomposes Li₂CO₃ on the surface of the negative electrode active material to produce carbon dioxide (CO₂).

Table 3 indicates that when the negative electrode active material is represented by MOₓ, preferably x<1 and that the number of water molecules per Si atom contained in the active material is preferably 0.002 or less.

### Example 5

Using Si, Sn, or Pb as the target, argon sputtering was performed to deposit Si, Sn, or Pb on a surface of a cooled 10-μm thick copper foil. In this way, negative electrode sheets were prepared. At this time, oxygen was introduced at a concentration of 1% into the chamber to cause a reaction between part of Si, Sn, or Pb and oxygen. All the deposited compounds were amorphous, and their compositions were found to be oxides (negative electrode active materials) represented by SiO_{0.21}, SnO_{0.17}, and PbO_{0.24}, respectively.

Each of these oxides (negative electrode active materials) was scraped off from the copper foil, and the scraped oxide was introduced into a planetary ballmill and pulverized in an argon atmosphere until the particle size became submicrons.

The oxide powder thus obtained was heated at 0.0013 MPa and 700° C. for 5 hours to reduce the water content. The water content of the resultant powder was measured in the same manner as in Example 1. As a result, the calculated water content of each oxide powder was approximately 0.0007 molecule per atom of Si, Sn, or Pb.

Subsequently, the surface of the negative electrode active material deposited on each of the negative electrode sheets was sprayed with the same ethanol solution of lithium nitrate as that prepared in Example 2, so that the amount of lithium nitrate added was 0.05 mol per mol of the element M in the negative electrode active material (raw material) after the spraying. Thereafter, in an argon atmosphere containing 3% carbon dioxide, a heat treatment was performed at 550° C. for SiO_{0.21}, 200° C. for SnO_{0.17}, and 270° C. for PbO_{0.24}. At this time, the lithium nitrate adhering to the surface partially decomposed and reacted with each oxide. The unreacted lithium nitrate was removed using dehydrated ethanol. The final ratios between the metal element and oxygen were: SiO_{0.26} (negative electrode active material S), SnO_{0.20} (negative electrode active material T), and PbO_{0.28} (negative electrode active material U). Also, Si was observed to be slightly alloyed with copper at the interface with the copper foil.

The negative electrode sheet was cut to a size of 35 mm×35 mm and ultrasonically welded to a copper plate with a lead to produce a negative electrode. Using this negative electrode, a test lithium ion battery was fabricated in the same manner as in Example 1. The battery was subjected to repeated charge/discharge cycles at a cut off voltage of charge of 4.2 V, a cut off voltage of discharge of 2.5 V, and a constant current of 3.5 mA. The discharge capacity of the battery after 200 cycles was divided by the discharge capacity after 5 cycles, and the obtained value was defined as capacity retention rate. Table 4 shows the measurement results.

TABLE 4

| Negative electrode | Composition of | Capacity |
|---|---|---|
| active material | negative electrode | retention |
| No. | active material | rate |
| S | SiO_{0.26} | 81% |
| T | SnO_{0.20} | 77% |
| U | PbO_{0.28} | 68% |

Table 4 indicates that the use of Si or Sn as the element M capable of forming an intermetallic compound with Li leads to an improvement in capacity retention rate. This is probably due to reactivity with lithium nitrate and alloying of the negative electrode active material with the copper foil.

The negative electrode active material of the invention is suitable for use in non-aqueous electrolyte secondary batteries which are required to provide high capacity and good cycle characteristics, such as lithium ion batteries. The non-aqueous electrolyte secondary battery of the invention can be used in the same applications as conventional non-aqueous electrolyte secondary batteries, and is particularly useful as the power source for portable electronic devices such as notebook personal computers, cell phones, and small game machines. It can also be used, for example, as the power source for hybrid electric vehicles, electric vehicles, and fuel cell cars, the power source for power tools, vacuum cleaners, and robots, and the power source for plug-in hybrid electric vehicles.

Although the invention has been described in terms of the presently preferred embodiments, it is to be understood that such disclosure is not to be interpreted as limiting. Various alterations and modifications will no doubt become apparent to those skilled in the art to which the invention pertains, after having read the above disclosure. Accordingly, it is intended that the appended claims be interpreted as covering all alterations and modifications as fall within the true spirit and scope of the invention.

1. A negative electrode active material for a non-aqueous electrolyte secondary battery, comprising an element capable of forming an intermetallic compound with lithium, the negative electrode active material having a water content of 0 to 0.04 molecule per atom of the element.

2. The negative electrode active material in accordance with claim 1, wherein the water content is determined based on a value obtained by subtracting an amount of moisture released from the negative electrode active material heated from room temperature to 140° C. at a temperature increase rate of 1° C./sec from an amount of moisture released from the negative electrode active material heated from room temperature to 1000° C. at a temperature increase rate of 1° C./sec.

3. The negative electrode active material in accordance with claim 1, wherein the water content is 0.0001 to 0.02 molecule per atom of the element.

4. The negative electrode active material in accordance with claim 1, wherein the element forms an oxide.

5. The negative electrode active material in accordance with claim 4, wherein the oxide is represented by the formula: MOₓ wherein M is the element and 0<x<1.

6. The negative electrode active material in accordance with claim 5, wherein 0.05≦x≦0.98.

7. The negative electrode active material in accordance with claim 1, wherein the element is silicon or tin.

8. A non-aqueous electrolyte secondary battery comprising: a negative electrode including the negative electrode active material of claim 1; a positive electrode; a separator separating the negative electrode and the positive electrode; and a non-aqueous electrolyte.

9. A method for producing a negative electrode active material for a non-aqueous electrolyte secondary battery, the method comprising heating a simple substance of an element capable of forming an intermetallic compound with lithium or heating a compound containing the element in the presence of lithium nitrate to produce a negative electrode active material having a water content of 0 to 0.04 molecule per atom of the element.

10. The method for producing a negative electrode active material in accordance with claim 9, wherein the compound is an oxide of the element.

11. The method for producing a negative electrode active material in accordance with claim 9, wherein the heating is performed at 150 to 800° C.

12. The method for producing a negative electrode active material in accordance with claim 9, wherein the amount of the lithium nitrate is 0.01 to 0.3 mol per mol of the simple substance or compound.

13. The method for producing a negative electrode active material in accordance with claim 9, comprising, before the heating, bringing the simple substance or compound into contact with an organic solvent solution containing the lithium nitrate and then drying the simple substance or compound to add the lithium nitrate to the simple substance or compound.

14. The method for producing a negative electrode active material in accordance with claim 9, comprising, before the heating, forming the simple substance or compound into a thin film and spraying an organic solvent solution containing the lithium nitrate on the thin film to add the lithium nitrate to the simple substance or compound.

15. The method for producing a negative electrode active material in accordance with claim 9, wherein the heating is performed in an inert gas atmosphere containing 0.1 to 10% by volume of carbon dioxide.

16. The method for producing a negative electrode active material in accordance with claim 9, further comprising, after the heating, cooling the produced negative electrode active material in an inert gas atmosphere containing 0.1 to 10% by volume of carbon dioxide.
